(19) United States
(12) Patent Application Publication
(10) Pub. No.: US 2020/0106930 A1
(43) Pub. Date: Apr. 2, 2020

(54) VIDEO PROCESSING DEVICE, DISPLAY DEVICE, VIDEO PROCESSING METHOD, AND CONTROL COMPUTER-READABLE STORAGE MEDIUM

(71) Applicant: SHARP KABUSHIKI KAISHA, Sakai City, Osaka (JP)

(72) Inventor: NAOHIRO HOHJOH, Sakai City, Osaka (JP)

(21) Appl. No.: 16/620,728

(22) PCT Filed: May 24, 2018
(86) PCT No.: PCT/JP2018/019955

§ 371 Date: Dec. 9, 2019

(30) Foreign Application Priority Data
Jun. 15, 2017 (JP) 2017-117742

(51) Int. Cl. H04N 5/14; G06T 7/215; G06T 7/246; G06K 9/00

(52) U.S. Cl. CPC H04N 5/145; G06T 7/215; G06T 2207/20081; G06K 9/00248; G06T 2207/10016; G06T 7/246

(57) ABSTRACT

The invention has an object to reduce computing costs in object identification in a video to below conventional levels. A signal processing unit for processing a video composed of a plurality of frames includes: an object identification unit configured to identify an object represented in the video; and a window specification unit configured to specify, based on a position in an (N+1)-th frame of the video of a representation of the object that appears in an N-th frame, an identification target region to be subjected to object identification in the (N+1)-th frame by the object identification unit, where N is a natural number.

### TECHNICAL FIELD

The following disclosure relates to, for example, video processing devices for processing a video composed of a plurality of frames.

### BACKGROUND ART

Various video processing techniques have been proposed. For instance, Patent Literature 1 discloses a technique aimed at detecting a representation of a moving object in a video and identifying the type or attributes of the moving object with high accuracy.

Specifically, Patent Literature 1 discloses an object identification device including: (i) an object detection unit for detecting a moving object in a video; (ii) a trajectory calculation unit for calculating a trajectory of the moving object; and (iii) an object identification unit for identifying the type or attributes of the moving object on the basis of the shape of the trajectory of the moving object.

### CITATION LIST

### Patent Literature

Patent Literature 1: Japanese Unexamined Patent Application Publication, Tokukai, No. 2016-57998 (Publication Date: Apr. 21, 2016)

### SUMMARY OF INVENTION

### Technical Problem

The technique disclosed in Patent Literature 1, however, is not designed to exploit high-accuracy image recognition technology (e.g., deep learning-based image recognition) for the purpose of object identification. Meanwhile, if the technique disclosed in Patent Literature 1 is used to achieve such high-accuracy image recognition, the technique requires very high computing costs to identify an object in a video. The present disclosure, in an aspect thereof, has an object to reduce computing costs in object identification in a video to below conventional levels.

### Solution to Problem

To accomplish the object, the present disclosure, in an aspect thereof, is directed to a video processing device for processing a video composed of a plurality of frames, the video processing device including: an object identification unit configured to identify an object represented in the video; and a region specification unit configured to specify, based on a position in an (N+1)-th frame of the video of a representation of the object that appears in an N-th frame, an identification target region to be subjected to object identification in the (N+1)-th frame by the object identification unit, where N is a natural number.

To accomplish the object, the present disclosure, in another aspect thereof, is directed to a video processing method of processing a video composed of a plurality of frames, the method including: the object identification step of identifying an object represented in the video; and the region specification step of specifying, based on a position in an (N+1)-th frame of the video of a representation of the object that appears in an N-th frame, an identification target region to be subjected to object identification in the (N+1)-th frame in the object identification step, where N is a natural number.

### Advantageous Effects of Invention

The video processing device in accordance with an aspect of the present disclosure advantageously enables reduction of computing costs in object identification in a video to below conventional levels. The video processing method in accordance with another aspect of the present disclosure achieves similar advantages.

### BRIEF DESCRIPTION OF DRAWINGS

FIG. 1 is a functional block diagram of a configuration of major components of a display device in accordance with Embodiment 1.

FIG. 2 is a schematic diagram illustrating motion vectors.

FIG. 3 is a diagram illustrating an identification target region in the N-th frame.

FIG. 4 is a diagram representing an exemplary flow of histogram generation in the display device shown in FIG. 1.

Portions (a) and (b) of FIG. 5 are diagrams illustrating a block-containing condition.

Portions (a) and (b) of FIG. 6 are diagrams representing two exemplary histograms obtained in a histogram generation process.

Portions (a) to (c) of FIG. 7 are diagrams representing exemplary sets of data used or specified in a histogram generation process.

FIG. 8 is a diagram representing an exemplary flow of histogram analysis in the display device shown in FIG. 1.

FIG. 9 is a diagram representing an exemplary set of identification target region candidates.

FIG. 10 is a diagram representing an exemplary result of object identification performed on a set of identification target region candidates.

FIG. 11 is a diagram illustrating differences between identification target regions in the (N+1)-th frame.

Portions (a) and (b) of FIG. 12 are diagrams representing exemplary changes from the (N−1)-th frame to the N-th frame in the distribution of values in two histograms in accordance with Embodiment 2.

FIG. 13 is a diagram representing exemplary specification of an identification target region candidate in the (N+1)-th frame in accordance with Embodiment 2, which is achieved by scaling up an identification target region from the N-th frame.

FIG. 14 is a functional block diagram of a configuration of major components of a video processing device in accordance with Embodiment 3.

FIG. 15 is a functional block diagram of a configuration of major components of a video processing device in accordance with Embodiment 4.

### DESCRIPTION OF EMBODIMENTS

### Embodiment 1

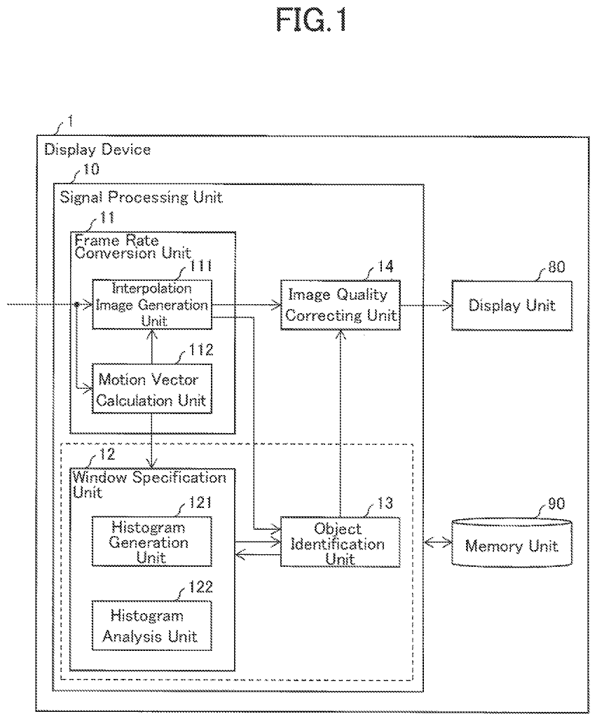

The following will describe Embodiment 1 in detail with reference to FIGS. 1 to 11. First, referring to FIG. 1, a brief description will be given of a display device 1 in accordance with Embodiment 1. FIG. 1 is a functional block diagram of a configuration of major components of the display device 1.

### Brief Description of Display Device 1

The display device 1 includes a signal processing unit 10 (video processing device), a display unit 80, and a memory unit 90. The display device 1 may be, for example, a television or a personal computer ((PC). Alternatively, the display device 1 may be a mobile information terminal such as a multifunctional mobile phone (smartphone) or tablet.

In the display device 1, the signal processing unit 10 processes a video (input video, input video signal) and outputs a processed video (output video, output video signal) to the display unit 80, as will be described in the following. The display unit 80 is a video display member and may be, for example, a liquid crystal display device or an organic light-emitting diode (OLED) display device.

An input video may be referred to as video A, and an output video may be referred to as video C, for convenience of description in Embodiment 1. Embodiment 1 illustrates, as an example, the signal processing unit 10 generating video B (intermediate video) before generating video C. Each video in Embodiment 1 is composed of a plurality of frames.

The signal processing unit 10 is provided as a part of a control unit (not shown) that collectively controls all the units in the display device 1. The functions of the control unit may be realized by a central processing unit (CPU) running programs contained in the memory unit 90. The functions of various units in the signal processing unit 10 will be described later in further detail. The memory unit 90 contains various programs that are run by the signal processing unit 10 and the data used by the programs.

Embodiment 1 gives an example where video A is externally fed to the signal processing unit 10 (more specifically, to a frame rate conversion unit 11, which will be described later in detail). Video A may be generated in the display device 1 by, for example, a tuner (not shown) in the display device 1 receiving and decoding external broadcasting waves (radio waves). In such cases, the tuner supplies video A to the signal processing unit 10.

Video A is processed in the signal processing unit 10. As an example, video A may have a 4K2K resolution of 3,840 (horizontal)×2,160 (vertical) pixels. Note that the resolution of each video described in Embodiment 1 is not necessarily limited to this example and may be specified in a suitable manner. For instance, video A may have a full HD resolution of 1,920 (horizontal)×1,080 (vertical) pixels or an 8K4K resolution of 7,680 (horizontal)×4,320 (vertical) pixels.

The signal processing unit 10 may obtain video A from the memory unit 90 if the memory unit 90 contains video A in advance. Alternatively, the signal processing unit 10 may obtain video A from an external device (e.g., a digital movie camera) connected to the display device 1.

The signal processing unit 10 processes video A (input video) in order to generate video C (output video), as will be described in the following. The signal processing unit 10 (more specifically, an image quality correcting unit 14, which will be described later in detail) then supplies video C to the display unit 80, so that the display unit 80 can display video C. The display control unit (not shown) controlling the operations of the display unit 80 may be provided in the signal processing unit 10 or in the display unit 80 itself.

### Signal Processing Unit 10

A description will be given next of a specific configuration of the signal processing unit 10. Referring to FIG. 1, the signal processing unit 10 includes the frame rate conversion unit 11, a window specification unit 12 (region specification unit), an object identification unit 13, and the image quality correcting unit 14.

The window specification unit 12 and the object identification unit 13 are major components of a video processing device in accordance with an aspect of the present disclosure, as will be described in the following. The window specification unit 12 and the object identification unit 13 may be collectively referred to as an “identification processing unit.” FIG. 1 and the drawings referenced hereinafter show the identification processing unit surrounded by a dotted line for convenience of description.

The frame rate conversion unit 11 includes an interpolation image generation unit 111 and a motion vector calculation unit 112. Video A is supplied to both the interpolation image generation unit 111 and the motion vector calculation unit 112.

The interpolation image generation unit 111 increases the frame rate of video A. Specifically, the interpolation image generation unit 111 extracts each frame of video A from video A. The frames extracted by the interpolation image generation unit 111 may be stored in, for example, a frame memory (not shown) that may be provided inside or outside the frame rate conversion unit 11.

Subsequently, the interpolation image generation unit 111 generates interpolation frames (intermediate frames) on the basis of the extracted frames using a publicly known algorithm. For instance, the interpolation image generation unit 111 may generate interpolation frames using motion vectors described in the following. The interpolation image generation unit 111 then inserts an interpolation frame to video A at every predetermined frame interval to increase the frame rate of video A.

The video processed by the interpolation image generation unit 111 may be referred to as video B in the following description. The frame rate conversion unit 11, as an example, may increase the frame rate of video A by 2 folds. For instance, if the frame rate of video A is 60 fps (frames per second), the interpolation image generation unit 111 generates video B with a frame rate of 120 fps.

The frame rate conversion ratio by the frame rate conversion unit 11 is not necessarily limited to the example given above and may be specified in a suitable manner. In addition, the frame rate of each video described in Embodiment 1 is not necessarily limited to the example given above. The frame rate conversion unit 11 may increase the frame rate of video A (e.g., 24 fps) by 10 folds to generate video B with a frame rate of 240 fps.

The provision of the interpolation image generation unit 111 enables the frame rate of a video to be displayed on the display unit 80 to be converted in accordance with the specifications of the display unit 80. Note however that the interpolation image generation unit 111 is not an essential element of the signal processing unit 10 as will be described, for example, in Embodiment 3 detailed later. For instance, if the frame rate of video A is already compatible with the specifications of the display unit 80, it is not necessary to generate video B (convert the frame rate of video A) in the interpolation image generation unit 111.

The interpolation image generation unit 111 feeds video B to the image quality correcting unit 14. The interpolation image generation unit 111 also feeds at least a part of video B to the object identification unit 13. Embodiment 1 describes the interpolation image generation unit 111 feeding entire video B to the object identification unit 13 as an example.

The motion vector calculation unit 112 analyzes video A (more specifically, each frame of video A stored in the frame memory) to calculate (detect) motion vectors. The motion vector calculation unit 112 may use a publicly known algorithm to calculate motion vectors.

If the signal processing unit 10 includes no interpolation image generation unit 111, the motion vector calculation unit 112 may have the function of extracting each frame from video A. The signal processing unit 10 may further include no motion vector calculation unit 112 as will be described in Embodiment 4 detailed later. In other words, the frame rate conversion unit 11 (the interpolation image generation unit 111 and the motion vector calculation unit 112) is not an essential element of the signal processing unit 10.

A description will be given next of motion vectors. First, suppose that each frame of a video (e.g., video A) is divided into spatial blocks (regions). A motion vector is a vector representing a displacement from a block (more specifically, a virtual object in the block) in a frame (e.g., a reference frame) to a corresponding block in another frame following that frame (e.g., the frame that comes immediately after the reference frame).

In other words, a motion vector indicates to which position a block in a frame moves in a succeeding frame. The motion vector is used as an indicator of the amount of motion of a block.

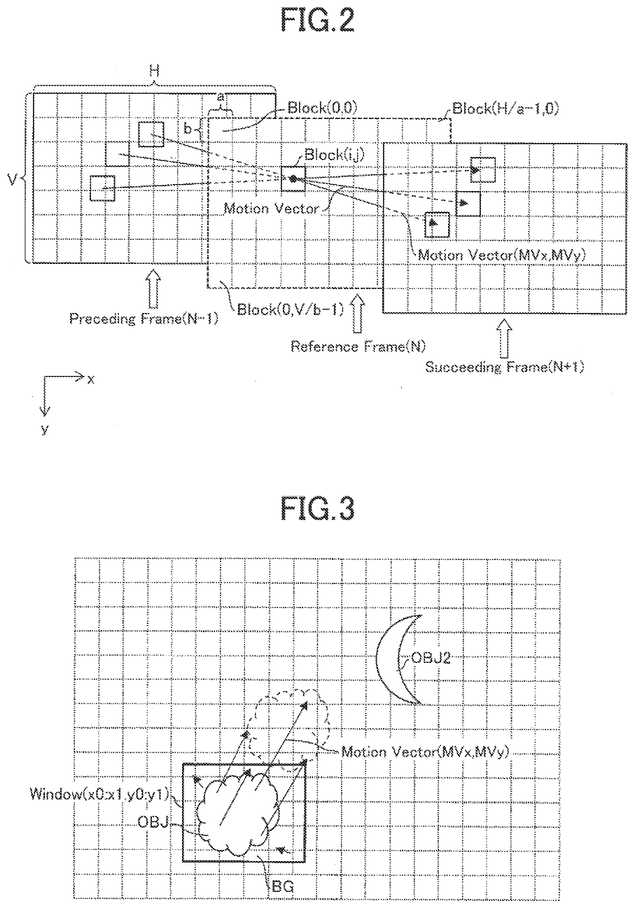

FIG. 2 is a schematic diagram illustrating motion vectors. Referring to FIG. 2, each frame in a video is divided into uniform blocks each of which has a horizontal dimension (resolution) of “a” and a vertical dimension of “b.” The horizontal pixel count of a video is denoted by H, and the vertical pixel count by V. The horizontal direction may be referred to as the x-direction, and the vertical direction as the y-direction.

Accordingly, each frame is divided by H/a in the horizontal direction and by V/b in the vertical direction. Accordingly, the frame is divided into H/a×V/b blocks. Note that a, b, H, and V may be set to suitable values. As an example, when a=b=1, each block matches a single pixel.

A block in FIG. 2 is denoted by Block(i,j), where i and j are numerical indicators of horizontal and vertical positions respectively in the frame, that is, i and j are ordinal numbers indicating x- and y-components respectively in an xy coordinate system.

The block in the upper left corner in FIG. 2 is denoted by Block(0,0). In FIG. 2, (i) the number indicating the horizontal position of a block increments by 1 from left to right, and (ii) the number indicating the vertical position of a block increments by 1 from top to bottom. Therefore, letting I=H/a−1 and J=V/b−1, it then follows that 0≤i≤I and 0≤j≤J.

Referring to FIG. 2, a motion vector for Block(i,j) is denoted by MV(i,j)=(MVx(i,j), MVy(i,j)). MVx is the x-component of a motion vector MV, and MVy is the y-component of the motion vector MV. Therefore, the motion vectors MV can be collectively denoted by MV=(MVx,MVy).

The motion vector calculation unit 112 calculates a motion vector (MVx,MVy) for each block in FIG. 2. The motion vector calculation unit 112 then supplies the motion vectors (MVx,MVy) to the interpolation image generation unit 111 and the window specification unit 12.

The window specification unit 12 includes a histogram generation unit 121 and a histogram analysis unit 122. The window specification unit 12 specifies an identification target region in the (N+1)-th frame (next frame) of a video (e.g., video B) (N is a natural number) on the basis of the position of a representation in the (N+1)-th frame of an object that appears in the N-th frame (current frame), as will be described in the following. An identification target region is a region where an object is subjected to object identification performed by the object identification unit 13.

More specifically, the window specification unit 12 specifies an identification target region in the (N+1)-th frame on the basis of one of motion vectors for the video that is contained in the identification target region in the N-th frame (the motion vector in the identification target region). The identification target region in the N-th frame contains at least a part of the representation of the object, as will be described in the following.

FIG. 3 is a diagram illustrating an identification target region in the N-th frame. Window(x0:x1,y0:y1) in FIG. 3 represents a quadrilateral (rectangle) having four points (x0,y0), (x0,y1), (x1,y1), and (x1,y0) as its vertices (see also, for example, FIG. 5 which will be described later in detail). Window(x0:x1,y0:y1) will be simply referred to as “Window” in the following description. Note that x0 and x1 are integers that satisfy 0≤x0 and x1≤H−1 respectively, and y0 and y1 are integers that satisfy 0≤y0 and y1≤V−1 respectively.

FIG. 3 shows an example where representations of two objects OBJ (e.g., cloud) and OBJ2 (e.g., the crescent moon) appear in the N-th frame. Embodiment 1 describes object OBJ as a target to be identified by the object identification unit 13. Accordingly, Window(x0:x1,y0:y1) is an identification target region in the N-th frame as will be described in the following. In the example in FIG. 3, Window(x0:x1,y0:y1) contains the entire representation of object OBJ and background BG of the representation of object OBJ.

The window specification unit 12 specifies an identification target region in the (N+1)-th frame on the basis of the motion vectors (MVx,MVy) contained in Window(x0:x1,y0:y1). It will be described later in detail how the window specification unit 12 specifies an identification target region (i.e., the specific operations of the histogram generation unit 121 and the histogram analysis unit 122).

The object identification unit 13 identifies an object in a video (e.g., video B). More specifically, the object identification unit 13 recognizes object OBJ contained in Window(x0:x1,y0:y1), which is an identification target region in the N-th frame, as shown in FIG. 3. More specifically, the object identification unit 13 detects a representation of object OBJ and identifies the object category to which object OBJ belongs (hereinafter, the “object category”). For instance, the object identification unit 13 identifies the object category of object OBJ as cloud.

The object identification unit 13 may use any suitable object identification method to identify an object (to identify an object category). As an example, the object identification method may involve deep learning technology, which is sometimes referred to as deep machine learning, and may alternatively be any publicly known object identification method that does not rely on deep learning technology.

Embodiment 1 given an example where the object identification unit 13 exploits machine learning using neural networks such as deep learning technology. In such an example, the object identification unit 13 develops an object-identifying model (object category-identifying model) from images of objects (e.g., reference images, which will be described later in detail) in advance by taking advantage of machine learning. This model will be referred to as the “pre-trained model” throughout the following description.

The object identification unit 13 is assumed to have a pre-trained model in the following description. The object identification unit 13 is capable of identifying object OBJ (identifying the object category of object OBJ) by matching object OBJ with the pre-trained model.

By using deep learning technology, the object identification unit 13 can identify an object with high accuracy in comparison with other publicly known object identification methods. Particularly, if the object identification unit 13 has developed a pre-trained model using abundant hardware resources, the object identification unit 13 is capable of identifying an object with higher accuracy.

Use of deep learning technology also eliminates the need for a design engineer of the display device 1 to prepare an object-identifying model in advance. Machine learning can therefore provide through its results a pre-trained model covering a variety of object textures.

It is known that object identification that relies on a pre-trained model obtained by neural networks such as deep learning technology requires relatively high computing costs. As described earlier, however, the object identification unit 13 needs only to identify an object within the identification target region in the N-th frame. The object identification unit 13 does not need to identify an object across the entire N-th frame. By thus selecting in advance a region on which the object identification unit 13 performs object identification, the computing costs in object identification can be efficiently reduced.

The object identification unit 13 generates object identification information representing results of identification of object OBJ in Window(x0:x1,y0:y1) to feed the generated object identification information to the image quality correcting unit 14. The object identification information can be used as one of indicators of the texture of object OBJ.

The image quality correcting unit 14 processes video B described above to generate video C (output video). The image quality correcting unit 14 then feeds video C to the display unit 80. The image quality correcting unit 14 may perform publicly known image quality correction on video B in accordance with the specifications of the display unit 80. Some examples of this image quality correction include color correction, contrast correction, edge correction, and image quality sharpening.

The image quality correcting unit 14 may further process video B in Embodiment 1 on the basis of the object identification information fed from the object identification unit 13 (i.e., in accordance with the results of identification performed by the object identification unit 13). In other words, the image quality correcting unit 14 may process video B in such a manner as to more effectively reproduce the texture of object OBJ. This particular processing improves the texture of object OBJ as reproduced in video C.

Conventionally, to sufficiently reproduce the texture of an object in a video, a video needs to be captured and recorded using a very high resolution camera (image capturing device) so that video signals in high resolution format can be fed to the display device 1 (video display device), for example, by using 8K4K or similar resolution format. If video data (described later) is compressed by a non-reversible method, the video may have a very high resolution, but is degraded in decoding the compressed video data. This degradation in turn lowers the texture reproduction quality of the video. Conventional technology has thus failed to provide an easy way to reproduce texture in a video in an effective manner.

The image quality correcting unit 14 is, however, enables effective reproduction of the texture of an object even if (i) the video does not have a sufficiently high resolution or (ii) the video has been degraded in the decoding of compressed video data. The image quality correcting unit 14, in other words, provides a simple and convenient alternative to conventional technology that sufficiently reproduces the texture of an object in a video.

As an example, when object OBJ is identified as belonging to an object category, “cloud,” the image quality correcting unit 14 may perform prescribed video processing (e.g., contour correction) to better reproduce the cloud's light and soft texture (lightness-producing touch).

### Flow of Histogram Generation in Window Specification Unit 12

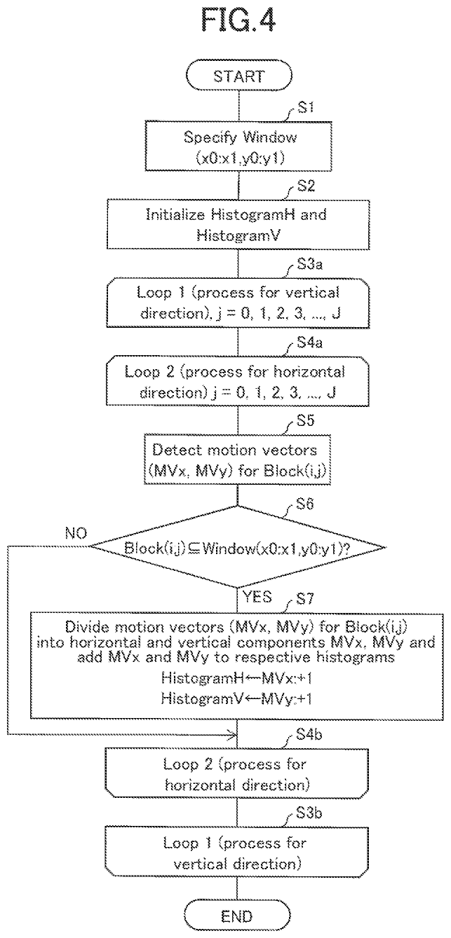

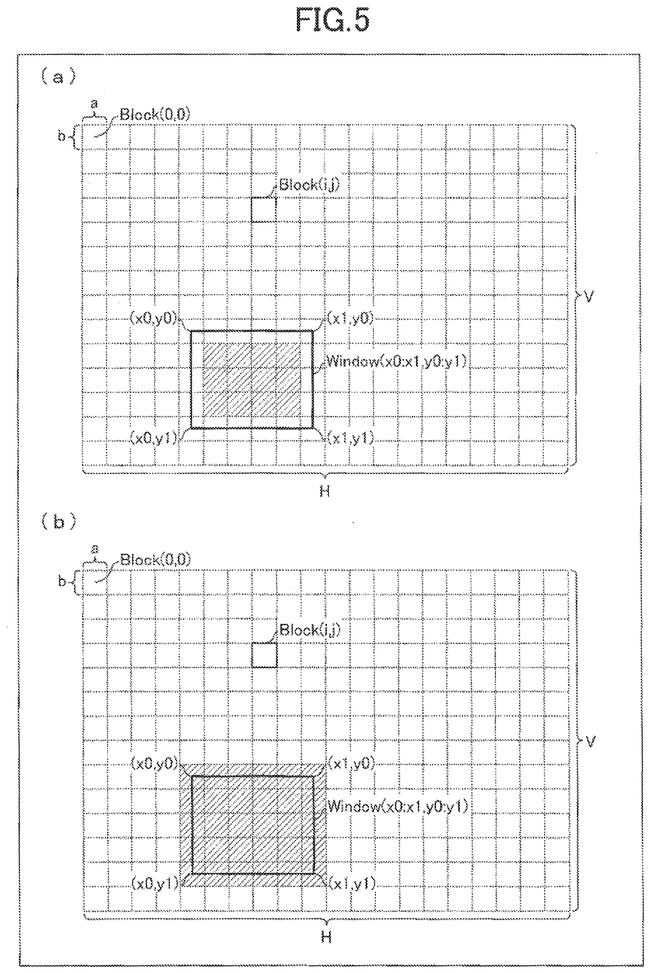

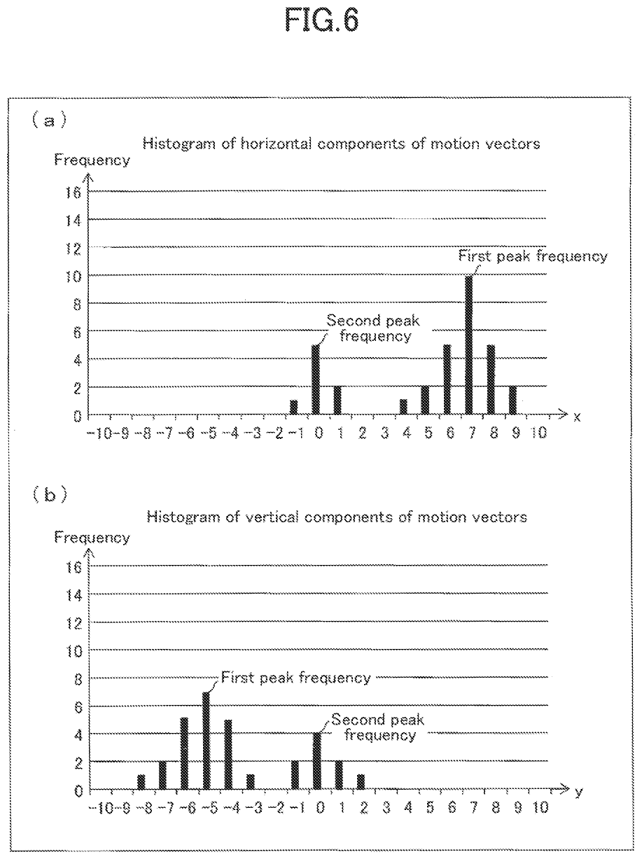

A specific description will be given next of the operations of the histogram generation unit 121 and the histogram analysis unit 122 in the window specification unit 12. The operations of the histogram generation unit 121 will be described first. FIG. 4 is a flow chart showing exemplary steps S1 to S3b executed by the histogram generation unit 121 and its peripheral functional units. The process in FIG. 4 may be referred to as histogram generation.

The histogram generation unit 121 generates a histogram for each frame of a video (every time a frame of a video is inputted). The following will describe as an example the histogram generation unit 121 processing the N-th frame of a video.

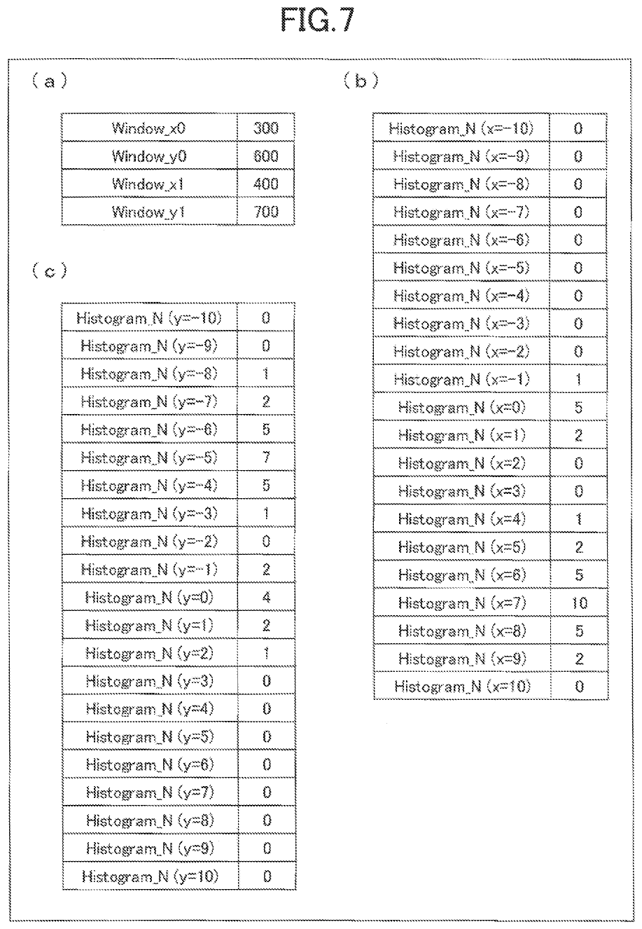

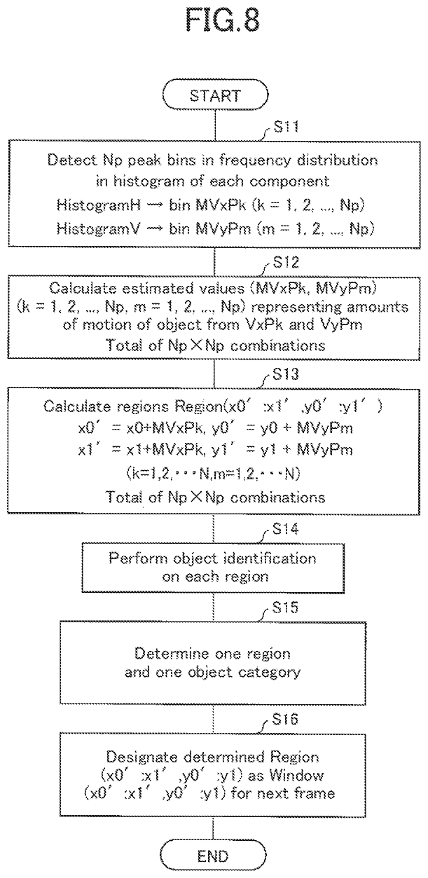

First, in step S1, the histogram analysis unit 122 (detailed later) specifies Window(x0:x1,y0:y1), which is an identification target region in the N-th frame, by a method that will be described later in detail with reference to FIG. 8 (see, especially, step S16 in FIG. 8).

Window(x0:x1,y0:y1) is defined by four values x0, x1, y0, and y1. These values are determined before a period in which effective data is inputted for the N-th frame (effective data period) and remain unchanged until the histogram generation process is completed. Portion (a) of FIG. 7 (detailed later) shows table of the four values x0, x1, y0, and y1. FIG. 7 shows tables of exemplary sets of data used or specified in a histogram generation process.

Suppose in the following description that x0=300, y0=600, x1=400, and y1=700 as shown in (a) of FIG. 7. Portion (a) of FIG. 7 lists these four parameters preceded by a prefix “Window” for convenience, to indicate that the parameters define a window.

The histogram generation unit 121 then generates a histogram of statistic values separately for the horizontal and vertical components of motion vectors contained in Window(x0:x1,y0:y1).

The histogram for the horizontal component of motion vectors will be referred to as HistogramH in the following description. HistogramH uses the horizontal component of motion vectors to define bins (to define values on the horizontal axis). The histogram for the vertical component of motion vectors will be referred to as HistogramV in the following description. HistogramV uses the vertical component of motion vectors to define bins.

First, in step S2, the histogram generation unit 121 initializes HistogramH and HistogramV. In other words, the histogram generation unit 121 sets the frequency (the value on the vertical axis) to 0 (i.e., clears settings) for all bins in HistogramH and HistogramV. In other words, the histogram generation unit 121 sets all frequencies to a null set (Φ) in HistogramH and HistogramV.

S3a to S3b in FIG. 4 are executed sequentially for each Block(i,j) throughout the above-described effective data period (i.e., throughout the entire N-th frame). S3a to S3b provide a loop representing a process for the vertical direction (loop 1). Loop 1 is executed in accordance with vertical scanning of a video throughout a vertical interval.

In other words, in loop 1, j is incremented by 1 from 0 to J (J=V/b−1) to select Block(i,j). The value of i is determined in loop 2 (described later). The steps included in loop 1 (i.e., S4a to S4b) are then sequentially and repeatedly executed in the order that Block(i,j) is selected.

S4a to S4b provide a loop representing a process for the horizontal direction (loop 2). Loop 2 is executed in accordance with horizontal scanning of a video throughout a horizontal interval. In other words, in loop 2, i is incremented by 1 from 0 to I (I=H/a−1) to select Block(i,j), using the prescribed value of j that is determined in loop 1. The steps included in loop 2 (i.e., S5 to S7) are then sequentially and repeatedly executed in the order that Block(i,j) is selected.

In step S5, the motion vector calculation unit 112 detects a motion vector (MVx,MVy) for Block(i,j). As described above, subsequently to S5, the interpolation image generation unit 111 may generate interpolation frames using the motion vector (MVx,MVy). The generation of interpolation frames by the interpolation image generation unit 111 does not affect the result of the histogram generation process.

In step S6, the histogram generation unit 121 determines whether or not Block(i,j), which is processed in S5 (where the motion vector (MVx,MVy) is detected), is contained in Window(x0:x1,y0:y1). Specifically, the histogram generation unit 121 determines whether or not a condition, “Block(i,j)⊆Window(x0:x1,y0:y1),” (hereinafter, a block-containing condition) is satisfied.

Portions (a) and (b) of FIG. 5 are diagrams illustrating a block-containing condition. As described earlier, Block(i,j) is a region with a size of a×b pixels. Specifically, Block(i,j) may have a size of, for example, 8×8 pixels or 16×16 pixels. In other words, a and b are set to such values that Block(i,j) has a sufficiently smaller size than a representation of object OBJ. Therefore, Block(i,j) has a sufficiently smaller size than Window(x0:x1,y0:y1) (a region containing a representation of object OBJ) (see also FIG. 3 described above).

Therefore, the block-containing condition described above may be approximately rewritten, for example, as “(x0≤a×i)∧(a×(i+1)≤x1)∧(y0≤b×j)∧(b×(j+1)≤y1) is true,” which may be referred to as a first determining condition.

The histogram generation unit 121 therefore can use the first determining condition to determine whether or not the block-containing condition is satisfied. Portion (a) of FIG. 5 indicates those blocks in prescribed Window(x0:x1,y0:y1) that satisfy the first determining condition by diagonal lines. In the example in (a) of FIG. 5, the 12 (=4×3) blocks indicated by diagonal lines are determined to satisfy the block-containing condition.

Alternatively, the block-containing condition described above may be approximately rewritten, for example, as “(x0≤a×(i+1))∧(a×1≤x1)∧(y0≤b×(j+1))∧(b×j≤y1) is true,” which may be referred to as a second determining condition.

The histogram generation unit 121 therefore can use the second determining condition to determine whether or not the block-containing condition is satisfied. Portion (b) of FIG. 5 indicates those blocks in Window(x0:x1,y0:y1) that satisfy the second determining condition by diagonal lines, similarly to (a) of FIG. 5.

In the example in (b) of FIG. 5, the 30 (=5×6) blocks indicated by diagonal lines are determined to satisfy the block-containing condition. More blocks are determined to satisfy the block-containing condition when the second determining condition is used than when the first determining condition is used, as described here. A design engineer of the display device 1 may select in a suitable manner which one of the first and second determining conditions to use in determining whether or not the block-containing condition is satisfied.

If Block(i,j) satisfies the block-containing condition (YES in step S6), the process proceeds to next step S7. On the other hand, if Block(i,j) does not satisfy the block-containing condition (NO in step S6), the process proceeds to S4b, skipping S7.

In step S7, the histogram generation unit 121 receives a motion vector (MVx,MVy) detected by the motion vector calculation unit 112 for each Block(i,j) in Window(x0:x1,y0:y1). The histogram generation unit 121 then obtains the values of the components MVx and MVy from the motion vector (MVx,MVy) (decomposes the motion vector into its horizontal and vertical components).

In Embodiment 1, HistogramH uses the values of component MVx on a per-pixel basis to define bins. Therefore, if there exists MVx having a prescribed value in single Block(i,j), the histogram generation unit 121 increments by 1 in HistogramH the frequency of a bin indicated by an integer value obtained by, for example, rounding that value of MVx.

For instance, if MVx=−1 in single Block(i,j) (i.e., if x-component MVx is detected of a motion vector representing the amount of motion equivalent to one pixel in the negative x-direction), the histogram generation unit 121 increments the frequency of “bin −1” by 1 in HistogramH.

HistogramV uses the values of component MVy on a per-pixel basis to define bins. Therefore, if there exists MVy having a prescribed value in single Block(i,j), the histogram generation unit 121 increments by 1 in HistogramV the frequency of a bin indicated by an integer value obtained by, for example, rounding that value of MVy. For instance, if MVy=1 in single Block(i,j) (i.e., if y-component MVy is detected of a motion vector representing the amount of motion equivalent to one pixel in the positive y-direction), the histogram generation unit 121 increments the frequency of “bin 1” by 1 in HistogramV.

Then, completion of loops 2 and 1 ends the histogram generation process. The histogram generation process is carried out parallel to the frame rate conversion process detailed earlier, so that the two processes are completed practically simultaneously.

Portions (a) and (b) of FIG. 6 show examples of HistogramH and HistogramV, respectively, obtained upon the completion of the histogram generation process. FIG. 6 shows two histograms (HistogramH and HistogramV) obtained from the N-th frame, which is shown in FIG. 3.

Portions (b) and (c) of FIG. 7 show tables of the frequencies of the bins in HistogramH and HistogramV, respectively, in FIG. 6. Portions (b) and (c) of FIG. 7 show a prefix “Histogram_N” for convenience, to indicate that the histogram represents numerical values obtained from the N-th frame. Also for convenience of description, the bins for MVx and MVy are denoted simply by letters “x” and “y” respectively where appropriate in the following.

As shown in (a) of FIG. 6, HistogramH has a maximum frequency in the x-direction (the highest peak of frequency, which may hereinafter be referred to as the first peak frequency) in bin “x=7” (MVxP1, which will be detailed later). Specifically, the first peak frequency in the x-direction is equal to 10. The bin that shows the first peak frequency will be referred to as the first peak bin in the following description.

As shown in (b) of FIG. 6, HistogramV has a maximum frequency in the y-direction (the first peak frequency) in bin “y=−5” (MVyP1, which will be detailed later). Specifically, the first peak frequency in the y-direction is equal to 7.

That “x=7” is the first peak bin in the x-direction and “y=−5” is the first peak bin in the y-direction suggests that the general motion of OBJ in FIG. 3 is equivalent to 7 pixels in the positive x-direction and 5 pixels in the negative y-direction.

Furthermore, as shown in (a) of FIG. 6, HistogramH has the second highest peak of frequency, which may hereinafter be referred to as the second peak frequency, in the x-direction in bin “x=0” (MVxP2, which will be detailed later). Specifically, the second peak frequency in the x-direction is equal to 5. The bin that shows the second peak frequency will be referred to as the second peak bin in the following description.

In addition, as shown in (b) of FIG. 6, HistogramV has the second peak frequency in the y-direction in bin “y=0” (MVxP2, which will be detailed later). Specifically, the second peak frequency in the y-direction is equal to 4.

That “x=0” is the second peak bin in the x-direction and “y=0” is the second peak bin in the y-direction suggests that background BG in FIG. 3 is substantially stationary (background BG moves neither in the x-direction nor in the y-direction).

### Flow of Histogram Analysis Process in Window Specification Unit 12

A description will be given next of the operations of the histogram analysis unit 122. FIG. 8 is a flow chart showing exemplary steps S11 to S16 executed by the histogram analysis unit 122 and its peripheral functional units. The process in FIG. 8 may be referred to as histogram analysis. The histogram analysis process is performed after the completion of the histogram generation process detailed above (in other words, after the completion of the frame rate conversion process).

In step S11, the histogram analysis unit 122 acquires HistogramH and HistogramV generated by the histogram generation unit 121 in the histogram generation process. The histogram analysis unit 122 then searches for a peak bin (bin that shows a peak of frequency (local maximum value)) in a frequency distribution in both HistogramH and HistogramV. The search for a peak bin may be performed using a publicly known algorithm.

For instance, the histogram analysis unit 122, first of all, finds a first peak bin, which is a bin that shows the first peak frequency (a global maximum frequency)). The histogram analysis unit 122 subsequently finds a second peak bin, which is a bin that shows the second highest frequency (second peak frequency) and that is not adjacent to the first peak bin. The histogram analysis unit 122 then finds a third peak bin, which is a bin that shows a third highest frequency (third peak frequency) and that is not adjacent to the first and second peak bins. Similar steps are repeated for a suitable number of times to search for Np peak bins.

Assume, in the following description, that HistogramH and HistogramV each have Np peak bins. The k-th peak bin in the x-direction is denoted by MVxPk, and the m-th peak bin in the y-direction by MVyPm, where 1≤k≤Np and 1≤m≤Np.

Assume, as an example, that the histogram analysis unit 122 searches for Np=2 peak bins in each HistogramH and HistogramV in FIG. 6 by the process described above.

The histogram analysis unit 122 finds MVxP1=7 (first peak frequency=10) and MVxP2=0 (second peak frequency=5) in HistogramH (see (a) of FIG. 6 and (b) of FIG. 7).

The histogram analysis unit 122 also finds MVyP1=−5 (first peak frequency=7) and MVyP2=0 (second peak frequency=4) in HistogramV (see (b) of FIG. 6 and (c) of FIG. 7).

In step S12, the histogram analysis unit 122 calculates estimated values of the amounts of motion of the object (hereinafter, “estimated amounts of motion”) using MVxPk and MVyPm obtained in step S11. Specifically, the histogram analysis unit 122 calculates Np×Np=Np² estimated amounts of motion. More specifically, the histogram analysis unit 122 calculates estimated amounts of motion as two-dimensional vectors by combining Np MVxPk values and Np MVyPm values.

For instance, the histogram analysis unit 122 calculates (specifies) estimated amounts of motion by taking Np MVxPk values as the x-components of the estimated amounts of motion and taking Np MVyPm values as the y-components of the estimated amounts of motion. In the above-described example, the histogram analysis unit 122 calculates four estimated amounts of motion:

(MVxP1, MVyP1)=(7,−5);

(MVxP1, MVyP2)=(7,0);

(MVxP2, MVyP1)=(0,−5); and

(MVxP2, MVyP2)=(0,0).

The histogram analysis unit 122 however does not necessarily calculate Np² estimated amounts of motion (all combinations). For instance, the histogram analysis unit 122 may perform some kind of estimation to skip the calculation of some of the combinations of the Np MVxPk values and the Np MVyPm values. In such cases, the number of the estimated amounts of motion may be reduced to less than Np², which can reduce computing costs in the calculation of the estimated amounts of motion.

The histogram analysis unit 122, in step S13, specifies Np² regions Region(x0′:x1′,y0′:y1′) on the basis of Window(x0:x1,y0:y1) (identification target region in the N-th frame) using Np² estimated amounts of motion obtained in step S12. Region(x0′:x1′,y0′:y1′) denote quadrilaterals (rectangles) with four vertices (x0′,y0′), (x0′,y1′), (x1′,y1′), and (x1′,y0′).

Each region Region(x0′:x1′,y0′:y1′) is a candidate for an identification target region in the (N+1)-th frame. For this reason, Region(x0′:x1′,y0′:y1′) may be referred to as an identification target region candidate. Region(x0′:x1′,y0′:y1′) in Embodiment 1 coincides with Window(x0:x1,y0:y1) displaced translationally by an estimated amount of motion.

In other words, Region(x0′:x1′,y0′:y1′) can be understood as being the region specified by moving Window(x0:x1,y0:y1) so as to track the motion of an object while preserving the shape of Window(x0:x1,y0:y1).

Specifically, the histogram analysis unit 122 specifies Region(x0′:x1′,y0′:y1′) by calculating four values x0′, x1′, y0′, and y1′. More specifically, the histogram analysis unit 122 calculates Np² sets of x0′, x1′, y0′, and y1′ (i.e., specifies Np² identification target region candidates) where:

x0′=x0+MVxPk (k=1, 2, . . . , Np);

x1′=x1+MVxPk (k=1, 2, . . . , Np);

y0′=y0+MVyPm (m=1, 2, . . . , Np); and

y1′=y1+MVyPm (m=1, 2, . . . , Np).

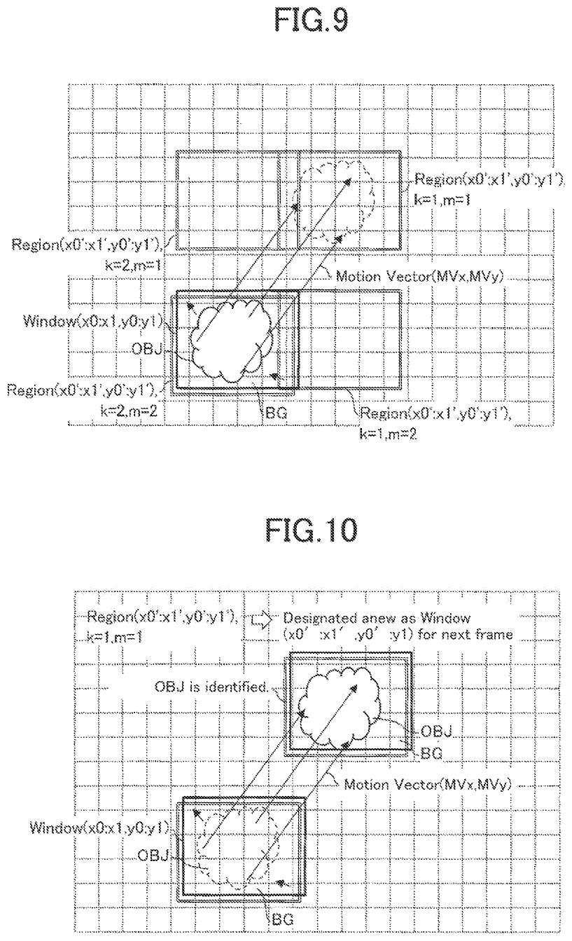

A description will be given next of an example using the specific numerical values given above, with reference to FIG. 9. FIG. 9 is a diagram representing four regions Region(x0′:x1′,y0′:y1′) (i.e., exemplary identification target region candidates) specified by the histogram analysis unit 122.

k=1, m=1

When k=1 and m=1, the histogram analysis unit 122 specifies Region(x0′,x1′,y0′,y1′) where:

x0′=x0+7;

x1′=x1+7;

y0′=y0−5; and

y1′=y1−5.

This identification target region candidate will be referred to as a first identification target region candidate in the following description. The first identification target region candidate coincides with Window(x0:x1,y0:y1) displaced in the x- and y-directions.
k=2, m=1

When k=2 and m=1, the histogram analysis unit 122 specifies Region(x0′:x1′,y0′:y1′) where:

x0′=x0;

x1′=x1;

y0′=y0−5; and

y1′=y1−5.

This identification target region candidate will be referred to as a second identification target region candidate in the following description. The second identification target region candidate coincides with Window(x0:x1,y0:y1) displaced only in the y-direction.
k=1, m=2

When k=1 and m=2, the histogram analysis unit 122 specifies Region(x0′,x1′,y0′,y1′) where:

x0′=x0+7;

x1′=x1+7:

y0′=y0; and

y1′=y1.

This identification target region candidate will be referred to as a third identification target region candidate in the following description. The third identification target region candidate coincides with Window(x0:x1,y0:y1) displaced only in the x-direction.

k=2, m=2

When k=2 and m=2, the histogram analysis unit 122 specifies Region(x0′,x1′,y0′,y1′) where:

x0′=x0;

x1′=x1;

y0′=y0; and

y1′=y1.

This identification target region candidate will be referred to as a fourth identification target region candidate in the following description. The fourth identification target region candidate coincides with Window(x0:x1,y0:y1).

In step S14 (object identification step), the object identification unit 13 identifies an object in each region Region(x0′:x1′,y0′:y1′) (in each of the first to fourth identification target region candidates). As described earlier, the object identification unit 13 identifies an object using a CNN (convolutional neural network) such as deep learning technology for the purpose of improving accuracy in object identification.

Narrowing down the regions subjected to object identification performed by the object identification unit 13 to the first to fourth identification target region candidates can efficiently reduce computing costs in object identification performed by the object identification unit 13 over the cases where the entire frame is subjected to object identification. Since the object identification performed using a CNN requires high computing costs as described earlier, this cost-reducing feature is particularly beneficial.

A CNN is not necessarily used only to identify objects. For instance, a CNN may be used to further identify, for example, scenes and materials.

Some known object-identifying techniques, including SIFT, SURF, and HOG, require relatively low computing costs (e.g., techniques that involve local feature extraction). Using these techniques, the entire frame may be subjected to object identification, but it is difficult to achieve a sufficient level of accuracy in object identification.

The display device 1 has a novel configuration conceived by the inventor of the present application (hereinafter, the “inventor”) for the purpose of simultaneously improving accuracy and reducing computing costs in object identification. More specifically, to achieve this purpose, the inventor has conceived a specific structure for the window specification unit 12 in the display device 1.

In step S15, the object identification unit 13 identifies, in the (N+1)-th frame, one of the first to fourth identification target region candidates that contains at least a part of a representation of an object identified in the N-th frame. For instance, the object identification unit 13 determines one of the results of the object identification performed on the first to fourth identification target region candidates as being correct.

For instance, CNN-based image classification typically gives results of object identification in the form of plural sets of object categories and their classification probabilities. Therefore, the object identification unit 13 may determine a category that yields a maximum classification probability as being correct, from the results of the object identification performed on the first to fourth identification target region candidates.

Now, a situation is considered where there is continuity between the image in the current frame and the image in the preceding frame (i.e., where the video includes, for example, no change of scenes). In such cases, it is reasonably expected that the results of object identification in the current frame has continuity with the results of object identification in the preceding frame. Therefore, the results of object identification in the preceding frame (category) may be recorded, and the classification probability may be corrected so as to add to the classification probability for the category in the current frame. This arrangement renders it more likely that an object of the same category as in the preceding frame be determined as being correct in the current frame (the object will more likely be identified).

FIG. 10 represents an exemplary result of the object identification performed in S15 by the object identification unit 13. In the example in FIG. 10, the object identification unit 13 detects an object in each of the first to fourth identification target region candidates in the (N+1)-th frame.

As a result, the object identification unit 13 determines that the first identification target region (i.e., Region(x0′:x1′,y0′:y1′) when k=1 and m=1) contains the entire representation of same object OBJ as in the N-th frame.

In step S16 (region specification step), the histogram analysis unit 122 designates, as the identification target region in the (N+1)-th frame, one of the first to fourth identification target region candidates that contains at least a part of a representation of object OBJ (in other words, the identification target region candidate identified in step S15 by the object identification unit 13).

FIG. 10 represents an exemplary result of the specification of a region in S16 by the histogram analysis unit 122. In the above-described example, the histogram analysis unit 122 designates Region(x0′,x1′,y0′,y1′), which is the first identification target region candidate, as the identification target region in the (N+1)-th frame, that is, as Window(x0′:x1′,y0′:y1′), on the basis of the result of the object identification performed in S15.

In other words, the histogram analysis unit 122 designates Region(x0+7:x1+7,y0−5:y1−5) as Window(x0′:x1′,y0′:y1′).

In S16, an identification target region of the same shape as the identification target region in the N-th frame can be specified in the (N+1)-th frame, by tracking the motion of object OBJ in one frame. Therefore, object OBJ can be identified also in the (N+1)-th frame as in the N-th frame.

Hence, an object can be identified in the current frame, and the motion of the object can be tracked to determine an identification target region for the next frame, by performing a histogram generation process and a histogram analysis process on the frames in the order of the first frame, the second frame, . . . the N-th frame, the (N+1)-th frame, . . . . Therefore, the moving object can be tracked, and the object can be identified in each frame.

### Effects of Display Device 1

As described earlier, in the display device 1, the window specification unit 12 specifies an identification target region in the (N+1)-th frame on the basis of the position of an object in the (N+1)-th frame of a video (i.e., on the basis of a result of object identification). That eliminates the need for the object identification unit 13 to perform object identification across each entire frame of the video, which can in turn reduce computing costs in object identification in the video to below conventional levels.

Specifically, the window specification unit 12 specifies an identification target region for the (N+1)-th frame on the basis of a motion vector contained in the identification target region in the N-th frame (more specifically, HistogramH and HistogramV, which represent the distributions of the horizontal and vertical components of motion vectors respectively). Therefore, the moving object (e.g., OBJ) can be tracked from one frame to the next, and an identification target region (more specifically, identification target region candidates) can be specified in each frame.

As an example, the window specification unit 12 may specify an identification target region for the (N+1)-th frame on the basis of a local maximum value in the distribution of the components of motion vectors (e.g., each peak frequency in the x- and y-directions). Specifically, the window specification unit 12 may use MVxPk and MVyPm described above (each peak bin that has a peak frequency in the x- and y-directions) to specify an identification target region for the (N+1)-th frame. This particular specification enables focusing on the general motion of an object, thereby achieving more efficient tracking of the object.

### Identification Target Region in Each Frame

To implement deep learning, many reference images (images used to learn to identify each object) need to be used. The reference images may be, for example, obtained from an image database called the “ImageNet.” Alternatively, deep learning may be implemented based on an existing pre-trained CNN model prepared using this image database.

Many reference image are available for use to learn various states of many objects. Reference images rarely contain an object that is not framed at all because either images are taken so as not to contain such an object or a process is carried out on captured images, in preparing the reference images.

Therefore, accuracy in object identification can vary markedly depending on whether or not the object is framed in a suitable manner in the image to be subjected to object identification by the display device 1 (identification target region in each frame) similarly to reference images. It is therefore important to specify an identification target region Window(x0:x1,y0:y1) in each frame in a suitable manner. In other words, it is important to specify identification target region candidate Region(x0′:x1′,y0′:y1′) in each frame in a suitable manner.

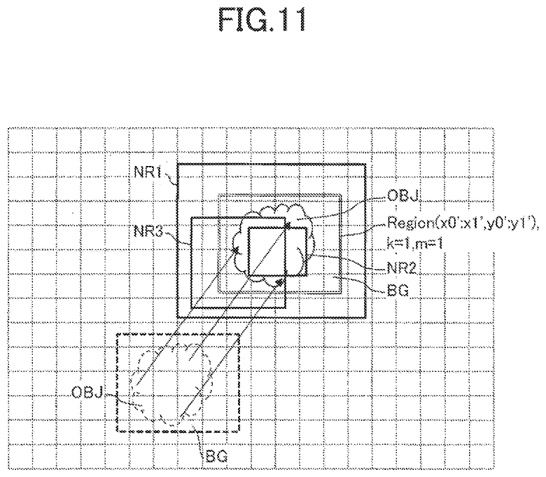

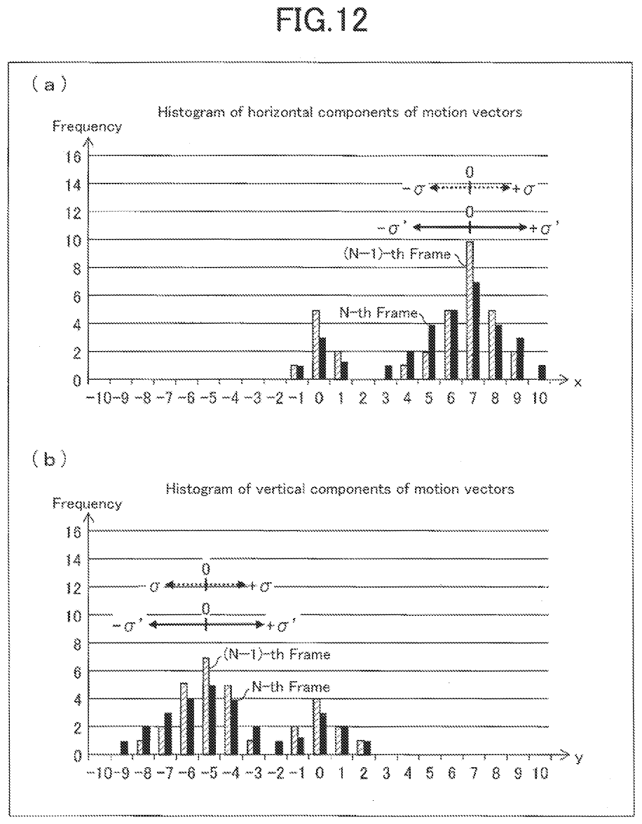

FIG. 11 is a diagram illustrating differences between identification target regions in the (N+1)-th frame. Region(x0′:x1′,y0′:y1′) (first identification region candidate), which is similar to FIG. 10 above, contains the entire representation of object OBJ (the entire representation of object OBJ is “framed in”), and object OBJ can be identified with high accuracy as described above.

On the other hand, region NR1 in FIG. 11 contains the entire representation of object OBJ and occupies a region larger than the first identification region candidate (a region that contains the first identification region candidate). In region NR1, the object region (the region that contains the representation of object OBJ) is relatively smaller in size than the noise region (the background and region that contains a representation of another framed-in object. Identification accuracy for object OBJ will therefore likely be low in region NR1.

For these reasons, to improve identification accuracy for object OBJ, the object region is preferably increased to some extent relative to the size of the noise region, like the first identification region candidate. Note however that region NR1 improves identification accuracy for object OBJ more than regions NR2 and NR3 described in the following because the overall shape (profile) of object OBJ is represented in region NR1.

Region NR2 in FIG. 11 contains a part the representation of object OBJ and is a region smaller than the first identification region candidate (a region that is contained in the first identification region candidate). A part of the representation of object OBJ is “framed out” in region NR2. Since the overall shape of object OBJ is not represented in region NR2, it is difficult to determine the overall shape of object OBJ. Identification accuracy for object OBJ will likely be lower in region NR2 than in region NR1.

Region NR3 in FIG. 11 is larger than region NR2. The representation of object OBJ is framed out more in region NR3 than in region NR2. The overall shape of object OBJ is more difficult to determine in region NR3. Therefore, identification accuracy for object OBJ will likely be even lower in region NR3 than in region NR2.

From these findings, the identification target region in each frame preferably contains the entire representation of object OBJ to improve identification accuracy for object OBJ. In other words, it is preferable that (i) the identification target region in the N-th frame contains the entire representation of object OBJ and (ii) the region specification unit specifies one of identification target region candidates that contains the entire representation of object OBJ in the (N+1)-th frame as the identification target region in the (N+1)-th frame.

To further improve identification accuracy for object OBJ, the object region is more preferably increased to some extent relative to the size of the noise region in the identification target region in each frame. As an example, the object region is preferably larger in area than the noise region in the identification target region in each frame.

Note however that the identification target region in each frame contains at least a part of the representation of object OBJ as described earlier because high accuracy object identification based on deep learning enables object identification in such an identification target region.

Accordingly, it is only required that (i) the identification target region in the N-th frame contains at least a part of the representation of object OBJ and (ii) the region specification unit designates one of identification target region candidates that contains at least a part of the representation of object OBJ in the (N+1)-th frame as the identification target region in the (N+1)-th frame.

### Embodiment 2

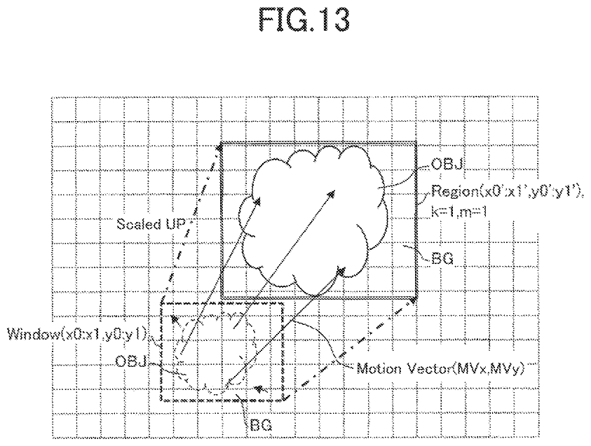

The following will describe Embodiment 2 with reference to FIGS. 12 and 13. For convenience of description, members of the present embodiment that have the same function as members of Embodiment 1 are indicated by the same reference numerals, and description thereof is omitted. Embodiment 2 will describe several variations of Embodiment 1 as first to fifth examples detailed below.

### First Example

Embodiment 1 divides a motion vector, which is a two-dimensional vector, into two components (horizontal and vertical components) to generate two one-dimensional histograms (HistogramH for the horizontal component and HistogramV for the vertical component) (e.g., S3a in FIG. 4). The two histograms are then analyzed (e.g., S11 and S12 in FIG. 8).

The motion vector is however not necessarily divided into components. The histogram generation unit 121 may generate a single two-dimensional histogram that represents a distribution of the two components of a motion vector. When this is actually the case, the histogram analysis unit 122 may search for the above-described peak bin by analyzing the two-dimensional histogram.

The estimated amount of motion can be more effectively narrowed down by analyzing a single two-dimensional histogram than by analyzing two one-dimensional histograms for the following reasons.

As described in Embodiment 1, 2×Np peak bins are found in the analysis of two one-dimensional histograms, Np peak bins for the x-component and another Np peak bins for the y-component. The peak bins for the x-component and the peak bins for the y-component are then combined to calculate an estimated amount of motion in the form of a two-dimensional vector, which means that Np² estimated amounts of motion are calculated as two-dimensional vectors.

On the other hand, in the analysis of a two-dimensional histogram, Np peak bins can be found as a set of two-dimensional vectors. Np estimated amounts of motion are therefore obtained as two-dimensional vectors. These facts indicate that the analysis of a two-dimensional histogram involves a fewer estimated amounts of motion than the analysis of two one-dimensional histograms. The analysis of a two-dimensional histogram however requires more complex peak bin search algorithms and will therefore likely involve more peak bin search calculation than the analysis of two one-dimensional histograms.

As described in the foregoing, the use of a two-dimensional histogram reduces the number of estimated amounts of motion, thereby reducing the number of identification target region candidates. As a result, the computing costs required in S14 in FIG. 8 (object identification) can be more efficiently reduced.

### Second Example

Embodiment 1 calculates x0′, x1′, y0′, and y1′ to specify Region(x0′:x1′,y0′:y1′), by using only estimated amounts of motion (combinations of MVxPk and MVyPm) (S13 in FIG. 8).

Random values (random terms) may be further introduced to additionally specify a plurality of identification target region candidates in the (N+1)-th frame. Specifically, the histogram analysis unit 122 may calculate x0″,x1″,y0″, and y1″ as given below:

x0″=x0′+Rand1;

x1″=x1′+Rand2:

y0″=y0′+Rand3; and

y1″=y1′+Rand4.

Rand1 to Rand4 are random integers that fall in a predetermined range of values that has a center value of 0. The histogram analysis unit 122 may then additionally designate two or more Region(x0″:x1″,y0″:y1″) as identification target region candidates in the (N+1)-th frame.

This particular specification of identification target region candidates for the (N+1)-th frame increases, over Embodiment 1, computing costs in specifying identification target region candidates and computing costs in object identification performed on the additionally specified identification target region candidates. The additional designation of Region(x0″:x1″,y0″:y1″) however enables the peripheral regions of Region(x0′:x1′,y0′:y1′) to be added to the identification target region candidates.

Therefore, accuracy is reasonably expected to improve in object identification even when, for example, the estimated amounts of motion are not specified in a suitable manner (the estimated amounts of motion include estimation errors) and object OBJ cannot be tracked in a suitable manner using Region(x0′:x1′,y0′:y1′).

### Third Example

Embodiment 1 designates one of regions Region(x0′:x1′,y0′:y1′) (identification target region candidates) as Window(x0′:x1′,y0′:y1′) for the (N+1)-th frame (the identification target region for the (N+1)-th frame) (step S16 in FIG. 8).

The identification target region may be however specified by a different method, for example, upon starting to feed a video and upon a change of scenes in the video. In other words, the identification target region in the first frame (initial frame) may be specified by a different method. For instance, any region in the first frame may be designated as the identification target region in a random manner.

Specifically, the histogram analysis unit 122 may calculate x0, x1, y0, and y1 for the first frame as given below:

x0=Rand (0˜H−1);

x1=Rand (0˜H−1);

y0=Rand (0˜V−1); and

y1=Rand (0˜V−1).

Rand(a˜b) is a function that outputs a random integer value that is in a range of from a to b, both inclusive. The histogram analysis unit 122 may then designate Window(x0:x1,y0:y1) as the identification target region in the first frame.

This particular specification of an identification target region for the first frame by the histogram analysis unit 122 enables object identification and specification of an identification target region in the second and subsequent frames through the processes described earlier with reference to FIGS. 4 and 8.

An identification target region may be specified for the first frame in response to a user's input operation (selected by a user). The histogram analysis unit 122 may use the values of x0, x1, y0, and y1 selected by the user in specifying Window(x0:x1,y0:y1) which is the identification target region in the first frame.

### Fourth Example

Embodiment 1 specifies one identification target region for each object to be subjected to object identification (e.g., OBJ) (hereinafter, the “first object”) (hereinafter, an “identification target region for the first object”). Embodiment 1 then uses the identification target region for the first object to track the first object and identify the first object.

Alternatively, a dedicated identification target region may be specified for each object in each frame of the video. For instance, in the example illustrated in FIG. 3, an additional dedicated identification target region (hereinafter, an “identification target region for the second object”) may be specified for a second object (e.g., OBJ2), which differs from the first object.

In such cases, the display device 1 may simultaneously (parallelly) perform the processes described earlier with reference to FIGS. 4 and 8 on both the identification target region for the first object and the identification target region for the second object. This configuration enables tracking and identification of each of the two objects (first and second objects) in each frame of the video. Providing a plurality of identification target regions in accordance with the number of objects to be subjected to object identification in this manner enables tracking and identification of each object.

A situation is considered where there is a plurality of objects to be identified with one of the objects having a markedly low classification probability. In this situation, the identification target region for the object may be initialized as in the third example above. This initialization is reasonably expected to improve identification accuracy for the object that has a low classification probability. The initialization also allows an identification target region to be specified to identify an object that appears anew in a middle frame of the video.

Alternatively, the identification target region for the object that has a markedly low classification probability may be deleted to suspend subsequent identification of the object. This configuration enables selective tracking of only those objects which have a relatively high identification accuracy. The configuration therefore reduces computing costs in identification of a plurality of objects.

### Fifth Example

Embodiment 1 specifies a plurality of regions Region(x0′:x1′,y0′:y1′) as being regions displaced translationally from Window(x0:x1,y0:y1). In other words, Embodiment 1 specifies identification target region candidates for the (N+1)-th frame as being regions that have the same size and shape as the identification target region in the N-th frame (regions that are congruent to the identification target region in the N-th frame).

Alternatively, the identification target region candidates in the (N+1)-th frame (i) may not be specified to have a different size from the identification target region in the N-th frame and (ii) may be specified to have a different shape from the identification target region in the N-th frame.

For instance, identification target region candidates that have a different size from the identification target region in the N-th frame may be specified for the (N+1)-th frame, by scaling up or down the identification target region. As an alternative, identification target region candidates that have a different shape from the identification target region in the N-th frame may be specified for the (N+l)-th frame, by deforming the identification target region.

As an example, if Region(x0′:x1′,y0′:y′) are specified as in the second example above, identification target region candidates that have a different size and shape from the identification target region in the N-th frame are obtained for the (N+1)-th frame.

The histogram analysis unit 122 may specify identification target region candidates for the (N+1)-th frame (next frame) by scaling up the identification target region for the N-th frame in accordance with changes from the (N−1)-th frame (preceding frame) to the N-th frame (current frame) in distribution in HistogramH and HistogramV.

FIG. 12 is a pair of graphs representing exemplary changes from the (N−1)-th frame to the N-th frame in the distribution of values (frequencies) in HistogramH and HistogramV. Portion (a) of FIG. 12 represents changes in distribution in HistogramH, and (b) of FIG. 12 represents changes in distribution in HistogramV.

In FIG. 12, a denotes a standard deviation in HistogramH and HistogramV in the (N−1)-th frame, whereas σ′ denotes a standard deviation in HistogramH and HistogramV in the N-th frame.

The standard deviations are denoted using the same symbols (σ and σ′) for both the x- and y-directions for convenience in the following description. The standard deviations may however have different values for the x- and y-directions.

Therefore, the standard deviations of the histograms in the (N−1)-th frame may be distinguished using different notations, for example, by denoting the standard deviation in HistogramH in the (N−1)-th frame by σx and denoting the standard deviation in HistogramV in the (N−1)-th frame by σy. Similarly, the standard deviations of the histograms in the N-th frame may be distinguished using different notations by denoting the standard deviation in HistogramH in the N-th frame by σ′x and denoting the standard deviation in HistogramV in the N-th frame by σ′y.

FIG. 12 shows that σ′>σ. This relationship indicates that the distribution is more spread in the N-th frame than in the (N−1)-th frame, which in turn indicates that the representation of the object in the (N−1)-th frame is scaled up in the N-th frame. It is therefore predicted that the representation of the object be further scaled up in the (N+1)-th frame than in the N-th frame if the video does not include, for example, any change of scenes.

Accordingly, if σ′>σ, the histogram analysis unit 122 may specify Region(x0′:x1′,y0′:y1′), which are identification target region candidates in the (N+1)-th frame, by translationally displacing and scaling up Window(x0:x1,y0:y1), which is the identification target region in the N-th frame, as shown in FIG. 13. FIG. 13 is a diagram representing exemplary specification of an identification target region candidate in the (N+1)-th frame by scaling up an identification target region from the N-th frame.

This particular specification of identification target region candidates in the next frame by scaling up the identification target region from the current frame enables specification of the size of the identification target region candidates in accordance with increases in the size of the object (e.g., OBJ) that is scaled up from one frame to the next. The particular specification thereby improves trackability and object identification accuracy when the object is scaled up from one frame to the next.

Meanwhile, if σ′<σ, the representation of the object in the (N−1)-th frame is expected to be scaled down in the N-th frame. Accordingly, if σ′<σ, the histogram analysis unit 122 may specify identification target region candidates for the (N+1)-th frame by translationally displacing and scaling down the identification target region in the N-th frame. This particular specification improves trackability and object identification accuracy also when the object is scaled down from one frame to the next.

As detailed in the foregoing, the histogram analysis unit 122 may specify identification target region candidates for the (N+1)-th frame (next frame) by scaling either up or down the identification target region from the N-th frame in accordance with whether σ′ is larger than σ or vice versa.

As an example, the histogram analysis unit 122 may scale the horizontal and vertical dimensions of the identification target region for the N-th frame by a factor of α to specify the horizontal and vertical dimensions of identification target region candidates for the (N+1)-th frame. The factor α may be referred to as the scaling ratio in the following description.

The value of α may be specified on the basis of σ′ and a. As an example, α=σ′/σ. In this example, if σ′>σ, then α>1, and the identification target region in the N-th frame is scaled up. On the other hand, if σ′<σ, then α<1, and the identification target region in the N-th frame is scaled down.

As described in the foregoing, the identification target region candidates for the (N+1)-th frame may be specified by (i) translationally displacing and (i) scaling either up or down the identification target region from the N-th frame.

The term, “scaling up/down,” as used in the present specification encompasses cases where α=1 (the identification target region in the N-th frame and the identification target region candidates in the (N+1)-th frame have the same size). Embodiment 1 concerns cases where α=1.

The histogram analysis unit 122 may therefore specify identification target region candidates for the (N+1)-th frame by translationally displacing the identification target region for the N-th frame and scaling either up or down the translationally displaced identification target region.

Furthermore, the horizontal and vertical dimensions of the identification target region may be scaled up or down by different factors. As an example, different scaling ratios may be specified for the x- and y-directions. For instance, letting the scaling ratio be equal to αx for the x-direction, αx may be specified to be equal to σ′x/σx. Similarly, letting the scaling ratio be equal to αy for the y-direction, αy may be specified to be equal to σ′y/σy.

The above-described example where the histogram analysis unit 122 may scale the horizontal and vertical dimensions of the identification target region for the N-th frame by a factor of α concerns a case where it is safely assumed that αx=αy. Generally, σx≠σy and σ′x≠σ′y. If the object is scaled up or down from one frame to the next by a constant aspect ratio, however, it then follows that αx≈αy. Therefore, it is safely assumed that αx=αy by approximation.

As described in the foregoing, the identification target region candidates in the (N+1)-th frame are not necessarily mathematically similar to the identification target region in the N-th frame.

Therefore, the histogram analysis unit 122 in the region specification unit needs only to specify an identification target region for each frame such that the identification target region (rectangle) for the N-th frame and the identification target region (rectangle) for the (N+1)-th frame have parallel sides. This particular specification enables specification of an identification target region for each frame at relatively low computing costs (e.g., through translational displacement and scaling).

### Variation Examples

The fifth example is an example where an identification target region is specified for the N-th frame by translationally displacing and scaling up or down the identification target region from the N-th frame.

The identification target region in the N-th frame may be translationally displaced, scaled up or down, and additionally rotated to specify an identification target region for the N-th frame. In other words, the identification target region candidates for the (N+1)-th frame may be specified as being mathematically similar to the identification target region for the N-th frame. Specifically, the histogram analysis unit 122 may specify identification target region candidates for the (N+1)-th frame by subjecting the identification target region for the N-th frame to a similarity transformation.

Furthermore, the horizontal and vertical dimensions of the identification target region may be scaled up or down by different factors as described above. For this reason, the identification target region candidates for the (N+1)-th frame are not necessarily mathematically similar to the identification target region for the N-th frame. The histogram analysis unit 122 may hence specify identification target region candidates for the (N+1)-th frame by subjecting the identification target region for the N-th frame to a linear transformation.

The histogram analysis unit 122 may subject the identification target region for the N-th frame to an affine transformation to specify identification target region candidates for the (N+1)-th frame.

### Embodiment 3

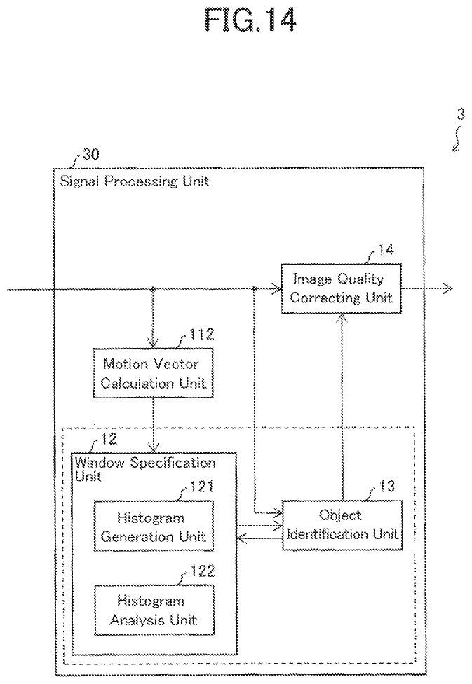

A description will be given of Embodiment 3 with reference to FIG. 14. FIG. 14 is a functional block diagram of a configuration of major components of a signal processing unit 30 (video processing device) in accordance with Embodiment 3. A display device in accordance with Embodiment 3 will be referred to as a display device 3. FIG. 14 omits some members and structures that are common with the display device 1 shown in FIG. 1, and their description is omitted. The same applies to Embodiment 4 which will be described later.

The signal processing unit 30 has the same configuration as the signal processing unit 10 of Embodiment 1, except that the signal processing unit 30 includes no interpolation image generation unit 111. With the interpolation image generation unit 111 being absent, the signal processing unit does not change the frame rate of video A (input video). Accordingly, no video B is generated. In the signal processing unit 30, video A (input video) is fed to the motion vector calculation unit 112, the object identification unit 13, and the image quality correcting unit 14.

In Embodiment 3, the motion vector calculation unit 112 extracts each frame from video A and calculates motion vectors for the video. The window specification unit 12 then specifies an identification target region for each frame of video A. Therefore, the object identification unit 13 performs object identification on the identification target region specified in each frame of video A.

Subsequently, the image quality correcting unit 14 processes video A in accordance with results of the identification performed by the object identification unit 13 to generate video C (output video). The image quality correcting unit 14 then feeds video C to the display unit 80.

As described here, the video processing device in accordance with an aspect of the present disclosure (e.g., the signal processing unit 30) may not include some of the elements that are not included in the above-mentioned identification processing unit (e.g., the interpolation image generation unit 111). The signal processing unit 30 provides a simpler video processing device configuration than Embodiment 1.

### Embodiment 4

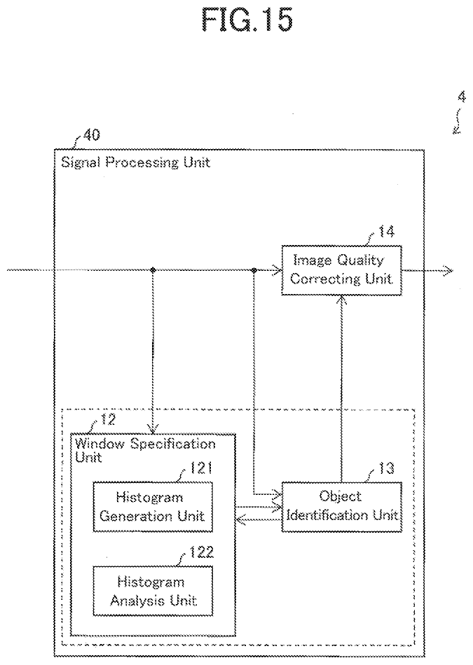

A description will be given of Embodiment 4 with reference to FIG. 15. FIG. 15 is a functional block diagram of a configuration of major components of a signal processing unit 40 (video processing device) in accordance with Embodiment 4. A display device in accordance with Embodiment 4 will be referred to as a display device 4.

As described earlier, video A may be generated by decoding video data compressed by a prescribed code scheme. Data for a video compressed by a prescribed code scheme (e.g., video A) will be referred to as compressed video data in the following description.

Embodiment 4 assumes that compressed video data includes in advance information representing motion vectors for compression (motion vector information). Compressed video data including motion vector information may be provided in, for example, the MPEG4 or like format.

The signal processing unit 40 has the same configuration as the signal processing unit 30 of Embodiment 3, except that the signal processing unit 40 includes no motion vector calculation unit 112. In other words, the signal processing unit 30 provides an even simpler video processing device configuration than Embodiment 3.

In the signal processing unit 40, video A is fed to the window specification unit 12, the object identification unit 13, and the image quality correcting unit 14. In the window specification unit 12 of Embodiment 4, the histogram generation unit 121 acquires motion vector information from the compressed video data to detect motion vectors in video A.

As described in the foregoing, the video processing device in accordance with an aspect of the present disclosure does not need to calculate motion vectors if compressed video data includes motion vector information, which further simplifies the configuration of the video processing device.

### Software Implementation

The control blocks of the display devices 1, 3, and 4 (particularly, the signal processing units 10, 30, and 40) may be implemented by logic circuits (hardware) fabricated, for example, in the form of an integrated circuit (IC chip) and may be implemented by software executed by a CPU (central processing unit).

In the latter form of implementation, the display devices 1, 3, and 4 each include, among others: a CPU that executes instructions from programs or software by which various functions are implemented; a ROM (read-only memory) or like storage device (referred to as a “storage medium”) containing the programs and various data in a computer-readable (or CPU-readable) format; and a RAM (random access memory) into which the programs are loaded. The computer (or CPU) then retrieves and executes the programs from the storage medium, thereby achieving the object of the present disclosure. The storage medium may be a “non-transient, tangible medium” such as a tape, a disc, a card, a semiconductor memory, or programmable logic circuitry. The programs may be supplied to the computer via any transmission medium (e.g., over a communications network or by broadcasting waves) that can transmit the programs. The present disclosure, in an aspect thereof, encompasses data signals on a carrier wave that are generated during electronic transmission of the programs.

### General Description

The present disclosure, in aspect 1 thereof, is directed to a video processing device (signal processing unit 10) for processing a video composed of a plurality of frames, the video processing device including: an object identification unit (13) configured to identify an object (OBJ) represented in the video; and a region specification unit (window specification unit 12) configured to specify, based on a position in an (N+1)-th frame of the video of a representation of the object that appears in an N-th frame, an identification target region (Window(x0′:x1′,y0′:y1′) to be subjected to object identification in the (N+1)-th frame by the object identification unit, where N is a natural number.

This configuration enables tracking of a moving object from one frame to the next and specification of an identification target region, both based on the position of the object in the (N+1)-th frame. Therefore, with the region specification unit specifying an identification target region in the (N+1)-th frame, the object identification unit does not need to perform object identification across the entire (N+1)-th frame.

Therefore, the object can be identified in the current frame, and an identification target region be specified for the succeeding frame, in the order of the first frame, the second frame, . . . the N-th frame, the (N+1)-th frame . . . . That eliminates the need for the object identification unit to perform object identification across each entire frame. That can in turn reduce computing costs in object identification to below conventional levels.

In aspect 2 of the present disclosure, the video processing device of aspect 1 is preferably configured such that an identification target region for the N-th frame (Window(x0:x1,y0:y1)) contains at least a part of the representation of the object, and the region specification unit specifies the identification target region for the (N+1)-th frame based on one of motion vectors in the video that is contained in the identification target region for the N-th frame.

This configuration enables tracking of a moving object from one frame to the next and specification of an identification target region, both based on a motion vector.

In aspect 3 of the present disclosure, the video processing device of aspect 2 is preferably configured such that the region specification unit specifies a plurality of identification target region candidates for the identification target region for the (N+1)-th frame based on the identification target region for the N-th frame and the motion vector contained in the identification target region, the object identification unit determines which one of the plurality of identification target region candidates in the (N+1)-th frame contains at least a part of the representation of the object, and the region specification unit designates one of the plurality of identification target region candidates in the (N+1)-th frame that contains at least a part of the representation of the object as the identification target region for the (N+1)-th frame.

This configuration enables specification of an identification target region in accordance with results of identification in each identification target region candidate, thereby achieving more efficient tracking of an object moving from one frame to the next.

In aspect 4 of the present disclosure, the video processing device of aspect 3 is preferably configured such that the region specification unit specifies the plurality of identification target region candidates for the (N+1)-th frame based on a statistic value of a distribution of a component of the motion vector contained in the identification target region for the N-th frame.

This configuration enables focusing on a motion of an object based on a statistic value, thereby achieving more efficient tracking of the object.

In aspect 5 of the present disclosure, the video processing device of aspect 4 is preferably configured such that the region specification unit specifies the plurality of identification target region candidates for the (N+1)-th frame based on a local maximum value of a distribution of a component of the motion vector contained in the identification target region for the N-th frame.

This configuration enables focusing on the general motion of an object based on a local maximum value, thereby achieving more efficient tracking of the object.

In aspect 6 of the present disclosure, the video processing device of any one of aspects 3 to 5 is preferably configured such that the identification target region for the N-th frame contains the entire representation of the object, and the region specification unit designates, as the identification target region for the (N+1)-th frame, one of the plurality of identification target region candidates for the (N+1)-th frame that contains the entire representation of the object.

This configuration allows the overall shape (profile) of an object to be represented in the identification target region for the N-th frame and the identification target region for the (N+1)-th frame, thereby improving accuracy in object identification performed by the object identification unit.

In aspect 7 of the present disclosure, the video processing device of any one of aspects 1 to 6 is preferably configured such that the region specification unit designates a rectangular region as the identification target region and specifies an identification target region for each frame such that the rectangular region in the N-th frame and the rectangular region in the (N+1)-th frame have parallel sides.

This configuration enables specification of an identification target region for the (N+1)-th frame, for example, through translational displacement and scaling of the identification target region for the N-th frame. In other words, the configuration enables specification of an identification target region for each frame at relatively low computing costs.

In aspect 8 of the present disclosure, the video processing device of any one of aspects 1 to 7 is preferably configured such that the object identification unit has a pre-trained model obtained by learning from a plurality of images of the object.

This configuration exploits a pre-trained model obtained by a CNN such as deep learning technology, thereby improving object identification accuracy. Narrowing targets in object identification down to identification target region candidates can efficiently reduce computing costs in object identification using a pre-trained model.

In aspect 9 of the present disclosure, the video processing device of any one of aspects 1 to 8 is preferably configured so as to further include an image quality correcting unit configured to process the video in accordance with a result of identification performed by the object identification unit.

This configuration enables video processing to be performed in accordance with results of object identification. For instance, the configuration enables video processing that more effectively reproduces the texture of an object, thereby improving the texture of an object represented in a video.

The present disclosure, in aspect 10 thereof, is preferably directed to a display device (1) including the video processing device of any one of aspects 1 to 9.

This configuration achieves the same advantages as does the video processing device in accordance with an aspect of the present disclosure.

The present disclosure, in aspect 11 thereof, is directed to a video processing method of processing a video composed of a plurality of frames, the method including: the object identification step of identifying an object represented in the video; and the region specification step of specifying, based on a position in an (N+1)-th frame of the video of a representation of the object that appears in an N-th frame, an identification target region to be subjected to object identification in the (N+1)-th frame in the object identification step, where N is a natural number.

This configuration achieves the same advantages as does the video processing device in accordance with an aspect of the present disclosure.

The video processing device of any aspect of the present disclosure may be implemented on a computer, in which case the present disclosure encompasses a control program that causes a computer to function as the various units (software elements) of the video processing device, thereby implementing the video processing device on the computer, and also encompasses a computer-readable storage medium containing the control program.

### Additional Remarks

The present disclosure is not limited to the description of the embodiments above and may be altered within the scope of the claims. Embodiments based on a proper combination of technical means disclosed in different embodiments are encompassed in the technical scope of the present disclosure. Furthermore, a new technological feature can be created by combining different technological means disclosed in the embodiments.

### CROSS-REFERENCE TO RELATED APPLICATIONS

The present application claims priority to Japanese Patent Application, Tokugan, No. 2017-117742 filed on Jun. 15, 2017, the entire contents of which are incorporated herein by reference.

### REFERENCE SIGNS LIST

1,3,4 Display Device
10,30,40 Signal Processing Unit (Video Processing Device)
12 Window Specification Unit (Region Specification Unit)
13 Object Identification Unit
14 Image Quality Correcting Unit
Window(x0:x1,y0:y1) Identification Target Region in N-th Frame
Window(x0′:x1′,y0′:y1′) Identification Target Region in (N+1)-th Frame
Region(x0′:x1′,y0′:y1′) Identification Target Region Candidate in (N+1)-th Frame
OBJ, OBJ2 Object

1. A video processing device for processing a video composed of a plurality of frames, the video processing device comprising:
an object identification unit configured to identify an object represented in the video; and
a region specification unit configured to specify, based on a position in an (N+1)-th frame of the video of a representation of the object that appears in an N-th frame, an identification target region to be subjected to object identification in the (N+1)-th frame by the object identification unit, where N is a natural number.

2. The video processing device according to claim 1, wherein
an identification target region for the N-th frame contains at least a part of the representation of the object, and
the region specification unit specifies the identification target region for the (N+1)-th frame based on one of motion vectors in the video that is contained in the identification target region for the N-th frame.

3. The video processing device according to claim 2, wherein
the region specification unit specifies a plurality of identification target region candidates for the identification target region for the (N+1)-th frame based on the identification target region for the N-th frame and the motion vector contained in the identification target region,
the object identification unit determines which one of the plurality of identification target region candidates in the (N+1)-th frame contains at least a part of the representation of the object, and
the region specification unit designates one of the plurality of identification target region candidates in the (N+1)-th frame that contains at least a part of the representation of the object as the identification target region for the (N+1)-th frame.

4. The video processing device according to claim 3, wherein the region specification unit specifies the plurality of identification target region candidates for the (N+1)-th frame based on a statistic value of a distribution of a component of the motion vector contained in the identification target region for the N-th frame.

5. The video processing device according to claim 4, wherein the region specification unit specifies the plurality of identification target region candidates for the (N+1)-th frame based on a local maximum value of a distribution of a component of the motion vector contained in the identification target region for the N-th frame.

6. The video processing device according to claim 3, wherein
the identification target region for the N-th frame contains the entire representation of the object, and
the region specification unit designates, as the identification target region for the (N+1)-th frame, one of the plurality of identification target region candidates for the (N+1)-th frame that contains the entire representation of the object.

7. The video processing device according to claim 1, wherein
the identification target regions for the frames are rectangular regions, and
the region specification unit specifies an identification target region for each frame such that the rectangular region in the N-th frame and the rectangular region in the (N+1)-th frame have parallel sides.

8. The video processing device according to claim 1, wherein the object identification unit has a learned model obtained by learning from a plurality of images of the object.

9. The video processing device according to claim 1, further comprising an image quality correcting unit configured to process the video in accordance with a result of identification performed by the object identification unit.

10. A display device comprising the video processing device according to claim 1.

11. A video processing method of processing a video composed of a plurality of frames, the method comprising:
the object identification step of identifying an object represented in the video; and
the region specification step of specifying, based on a position in an (N+1)-th frame of the video of a representation of the object that appears in an N-th frame, an identification target region to be subjected to object identification in the (N+1)-th frame in the object identification step, where N is a natural number.

12. A non-transitory computer-readable storage medium containing a control program causing a computer to operate as the video processing device according to claim 1, the program causing the computer to operate as the region specification unit and the object identification unit.
